(19) United States
(12) Patent Application Publication
(10) Pub. No.: US 2026/0257533 A1
(43) Pub. Date: Sep. 3, 2026

(54) VEHICLE AIR CONDITIONING DEVICE

(71) Applicant: TOYOTA JIDOSHA KABUSHIKI KAISHA, Toyota-shi (JP)

(72) Inventors: Keigo YOSHIDA, Nisshin-shi (JP); Yuki MATSUSHITA, Okazaki-shi (JP)

(21) Appl. No.: 19/530,357

(22) Filed: Feb. 5, 2026

(30) Foreign Application Priority Data
Feb. 28, 2025 (JP) 2025-031641

(51) Int. Cl. B60H 1/24

(52) U.S. Cl. CPC B60H 1/242

(57) ABSTRACT

A vehicle air conditioning device includes: an air conditioning unit that is provided further toward a vehicle front side than a dash panel; and an air conditioning duct that guides air, whose temperature has been adjusted at the air conditioning unit, to the vehicle cabin. The air conditioning duct includes: a connection duct that has an upstream end connected to the air conditioning unit, and a branched duct that has an upstream end connected to the connection duct, and at which air that has been guided from the connection duct is branched; the branched duct is provided at an interior of a console that is provided further toward a vehicle rear side than the dash panel; and the upstream end of the connection duct is connected to the air conditioning unit further toward the vehicle front side than the dash panel.

### CROSS-REFERENCE TO RELATED APPLICATION

This application is based on and claims priority under 35 USC 119 from Japanese Patent Application No. 2025-031641, filed on February 28, 2025, the disclosure of which is incorporated by reference herein.

### BACKGROUND

### Technical Field

The present disclosure relates to a vehicle air conditioning device.

### Related Art

Japanese Patent Application Laid-Open (JP-A) No. 2015-083397 discloses a vehicle air conditioning device that includes an air conditioning unit disposed at an interior of an instrument panel, and an air conditioning duct disposed at an interior of a center console extending rearward from the instrument panel, and that discharges temperature-adjusted air, which has been supplied to a front portion of the air conditioning duct from the air conditioning unit, into a vehicle cabin from a rear portion of the air conditioning duct.

In a vehicle air conditioning device, there are cases in which a connection portion between an air conditioning unit and an air conditioning duct is provided further toward a vehicle cabin side than a dash panel. In such cases, it is necessary to provide at least a connection portion of the air conditioning unit that is connected to the air conditioning duct, further toward the vehicle cabin side than the dash panel. Thus, it has been easy for a vehicle cabin interior space to be cramped by the air conditioning unit.

### SUMMARY

The present disclosure provides a vehicle air conditioning device that is capable of enlarging a vehicle cabin interior space.

A vehicle air conditioning device according to a first aspect includes: an air conditioning unit that is provided further toward a vehicle front side than a dash panel separating a vehicle cabin and a front compartment, and that adjusts a temperature of air that is guided to the vehicle cabin; and an air conditioning duct that guides air, whose temperature has been adjusted at the air conditioning unit, to the vehicle cabin, wherein: the air conditioning duct includes a connection duct that has an upstream end connected to the air conditioning unit, and a branched duct that has an upstream end connected to the connection duct, and at which air that has been guided from the connection duct is branched; the branched duct is provided at an interior of a console that is provided further toward a vehicle rear side than the dash panel; and the upstream end of the connection duct is connected to the air conditioning unit further toward the vehicle front side than the dash panel.

In the vehicle air conditioning device according to the first aspect, the branched duct is provided at the interior of the console. Consequently, the vehicle cabin interior space can be made larger compared to a case in which the branched duct is provided at an exterior of the console (that is to say, at the vehicle cabin).

Further, in the vehicle air conditioning device according to the first aspect, the upstream end of the connection duct is connected to the air-conditioning unit further toward the vehicle front side than the dash panel. Consequently, a portion of the air conditioning unit that is connected to the air conditioning duct (the connection duct) does not need to be provided further toward a vehicle cabin side than the dash panel. Accordingly, the vehicle cabin interior space can be made larger.

A vehicle air conditioning device according to a second aspect is the vehicle air conditioning device according to the first aspect, wherein the connection duct is disposed at a lower side of a floor carpet.

In the vehicle air conditioning device according to the second aspect, the connection duct is disposed at the lower side of the floor carpet. Consequently, the connection duct is less likely to cramp the vehicle cabin interior space. Accordingly, the vehicle cabin interior space can be made larger.

A vehicle air conditioning device according to a third aspect is the vehicle air conditioning device according to the first aspect or the second aspect, wherein: the branched duct is provided with a first discharge port and a second discharge port from which air is discharged; the console is provided with a first opening portion that is open toward the vehicle cabin at an upper portion of a rear end portion of the console, and a second opening portion that is open toward the vehicle cabin at a lower portion of the rear end portion of the console; and the air conditioning duct includes a first duct that connects the first opening portion of the console and the first discharge port of the branched duct, and a second duct that connects the second opening portion of the console and the second discharge port of the branched duct.

In the vehicle air conditioning device according to the third aspect, the air conditioning duct includes the first duct that connects the first opening portion of the console and the first discharge port of the branched duct, and a second duct that connects the second opening portion of the console and the second discharge port of the branched duct. That is to say, in the above-described configuration, the vehicle cabin interior space can be made larger in a structure in which air, whose temperature has been adjusted at the air conditioning unit, is discharged to the vehicle cabin interior space from plural locations (specifically, the first blowing port and the second blowing port).

A vehicle air conditioning device according to a fourth aspect is the vehicle air conditioning device according to the third aspect, wherein the branched duct includes a first lid portion that is capable of opening and closing the first discharge port, and a second lid portion that is capable of opening and closing the second discharge port.

In the vehicle air conditioning device according to the fourth aspect, the branched duct includes the first lid portion that is capable of opening and closing the first discharge port, and the second lid portion that is capable of opening and closing the second discharge port. Consequently, the branched duct can switch between states in which the first discharge port and the second discharge port are open and states in which the first discharge port and the second discharge port are closed. Accordingly, switching between a state in which air, whose temperature has been adjusted, is discharged from the first blowing port and a state in which the air is not discharged can be carried out. Further, switching between a state in which air, whose temperature has been adjusted, is discharged from the second blowing port and a state in which the air is not discharged can be carried out. Thus, the temperature of the vehicle cabin interior space can be suitably adjusted.

As explained above, the vehicle air conditioning device according to the present disclosure has an effect in that it can enlarge a vehicle cabin interior space.

### BRIEF DESCRIPTION OF THE DRAWINGS

An embodiment of the present disclosure will be described in detail based on the following figures, wherein:

FIG. 1 is a schematic vertical cross-sectional view illustrating a vehicle according to an exemplary embodiment of the present disclosure; and

FIG. 2 is a perspective view of a branched duct of a vehicle air conditioning device according to the exemplary embodiment of the present disclosure.

### DETAILED DESCRIPTION

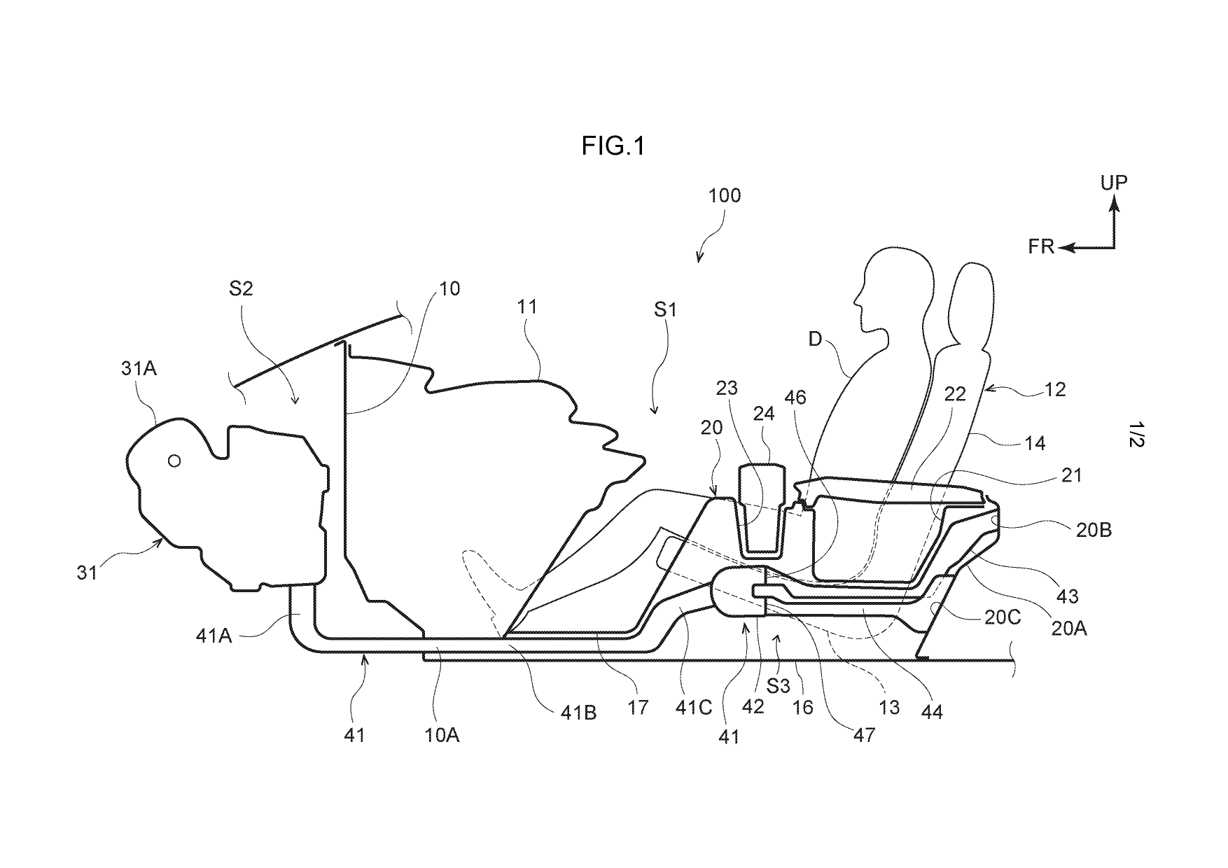

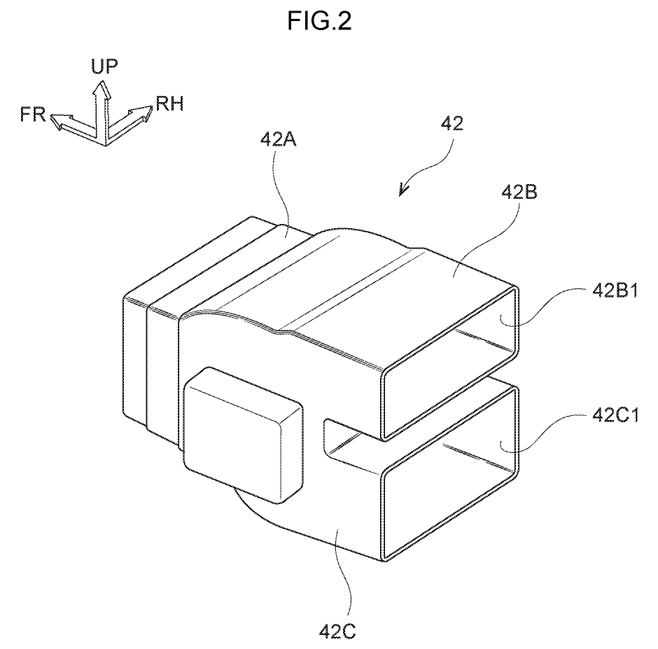

An exemplary embodiment of a vehicle air conditioning device according to the present disclosure will be explained below with reference to FIG. 1 and FIG. 2. It should be noted that, in each of the drawings as appropriate, arrow FR indicates a vehicle front side, which is a front side in a vehicle front-rear direction, arrow RH indicates a vehicle right side, which is a right side in a vehicle width direction, and arrow UP indicates a vehicle upper side, which is an upper side in a vehicle up-down direction. In the following explanation, a front-rear direction, a left-right direction, and an up-down direction respectively indicate the vehicle front-rear direction, the vehicle width direction, and the vehicle up-down direction. Further, left and right directions mean left and right directions in a state facing toward the vehicle front.

As illustrated in FIG. 1, a vehicle air conditioning device 30 according to the present exemplary embodiment is provided at a vehicle 100. The vehicle 100 includes a dash panel 10 that separates a vehicle cabin S1 and a front compartment, an instrument panel 11 that is provided at a vehicle cabin S1 side of the dash panel 10, a pair of seats 12 that are provided at a vehicle rear side of the instrument panel 11 and that are disposed side-by-side in the vehicle width direction at a predetermined spacing, a console 20 that is provided between the pair of seats 12, and a vehicle air conditioning device 30 that supplies temperature-adjusted air to the vehicle cabin S1.

The dash panel 10 is disposed at a front portion of the vehicle. The dash panel 10 is a plate-shaped member, and is disposed such that a plate face thereof is a face extending along the vehicle up-down direction and the vehicle width direction. The dash panel 10 separates an internal space of the vehicle cabin S1, in which an occupant D rides, and the front compartment S2.

Plural through holes 10A that penetrate in a plate thickness direction (in the present exemplary embodiment, the vehicle front-rear direction) are formed at a lower portion of the dash panel 10. A connection duct of the vehicle air conditioning device 30, which will be described later, is inserted through a through hole 10A.

The instrument panel 11 is provided at a vehicle rear side of the dash panel 10. A space is provided at an interior of the instrument panel 11, and various devices are accommodated in the space.

The pair of seats 12 are provided at a vehicle rear side of the instrument panel 11. The pair of seats 12 are provided so as to be separated from each other in the vehicle left-right direction. One of the pair of seats 12 is configured as a driver's seat. Further, the other of the pair of seats 12 is configured as a passenger seat. Each seat 12 includes a seat cushion 13 at which the occupant D sits, and a seatback 14 that is attached to a vehicle rear side portion of the seat cushion 13. A front side of the seat 12 faces toward the vehicle front side, and a body of the occupant D seated at the seat 12 faces toward the vehicle front side.

The console 20 is provided at the vehicle rear side of the dash panel 10. The console 20 is provided at a central portion in the vehicle width direction. The console 20 is provided between the pair of seats 12. The console 20 is provided so as to project out upward from a bottom portion of the vehicle cabin S1, and a space (hereafter referred to as an "internal space S3") is provided at an interior of the console 20. Specifically, the internal space S3 is provided between the console 20 and a floor panel 16. A portion of the floor panel 16 is covered by a floor carpet 17 from an upper side.

The console 20 includes a console box 21 and a cup holder 23 that is provided at a vehicle front side of the console box 21. Further, a rear end portion 20A of the console 20 is configured as a wall portion that extends in the up-down direction and the vehicle width direction, and faces a rear space at which a rear seat is provided (a space at a rear side of the driver's seat and the passenger seat within the vehicle cabin S1). A first blowing port (first opening portion) 20B and a second blowing port (second opening portion) 20C that are open to the rear space are provided at the rear end portion 20A. The second blowing port 20C is provided further toward the lower side than the first blowing port 20B.

The console box 21 is provided extending from a predetermined position in the vehicle front-rear direction to the rear end portion of the console 20. The console box 21 is provided so as to be recessed from an upper face of the console 20. An opening portion that is open to the vehicle cabin S1 is provided at an upper end of the console box 21.

An armrest 22 is provided at an upper portion of the console box 21 so as to cover the console box 21 from the vehicle upper side. The armrest 22 extends in the vehicle front-rear direction. A hinge shaft (which is not illustrated in the drawings) that is provided so as to be rotatable with an axial direction thereof along the vehicle width direction, is provided at a rear end portion of the console box 21. A rear end portion of the armrest 22 is connected to the hinge shaft. Consequently, the armrest 22 configures a lid body that opens and closes the opening portion provided at the upper end within the console box 21.

The cup holder 23 is provided at a vehicle front side of the armrest 22. The cup holder 23 is provided so as to be recessed from the upper face of the console 20. The cup holder 23 is configured such that a cup 24 can be accommodated therein.

### Vehicle Air Conditioning Device

The vehicle air conditioning device 30 is a device that supplies temperature-adjusted air to the vehicle cabin S1. The vehicle air conditioning device 30 includes an air conditioning unit 31 that is provided further toward the vehicle front side than the dash panel 10, and an air conditioning duct 40 that guides air, whose temperature has been adjusted by the air conditioning unit, to the vehicle cabin S1.

The entire air conditioning unit 31 is provided further toward the vehicle front side than the dash panel 10. That is to say, the entire air conditioning unit 31 is provided in the front compartment S2. The air conditioning unit 31 adjusts the temperature of the air that is guided to the vehicle cabin. The air conditioning unit 31 includes a housing 31A that serves as an outer shell, a heater (which is not illustrated in the drawings) that is accommodated at an interior of the housing 31A, and an evaporator (which is not illustrated in the drawings) that is accommodated at the interior of the housing 31A. Air is introduced into the interior of the housing 31A of the air conditioning unit 31. The air conditioning unit 31 adjusts the temperature of the air that has been introduced into the interior of the housing 31A by the heater or the evaporator, which configures a portion of a cooling cycle. It should be noted that a method by which the air conditioning unit 31 adjusts the temperature of the air is not limited to a specific method, and may be, for example, a method in which the temperature of the air is adjusted by adjusting an amount of air that is sent to the heater and an amount of air that is sent to the evaporator.

An opening is formed at a lower end of the housing 31A of the air conditioning unit 31, and the air conditioning duct 40 is connected to the opening. The air conditioning unit 31 supplies air, whose temperature has been adjusted within the housing 31A, to the vehicle cabin S1 via the air conditioning duct 40 and the like.

The air that has been temperature-adjusted at the air conditioning unit 31 flows through an interior of the air conditioning duct 40. The air conditioning duct 40 guides the air that has been temperature-adjusted at the air conditioning unit 31 to the rear space (the space at the rear side of the driver's seat and the passenger seat within the vehicle cabin S1). The air conditioning duct 40 includes a connection duct 41 that is connected to the air conditioning unit 31, a branched duct 42 that is connected to a downstream end of the connection duct 41, a first duct 43 that is connected to the branched duct 42, and a second duct 44 that is connected to the branched duct 42.

An upstream end of the connection duct 41 is connected to the air conditioning unit 31. More specifically, the upstream end of the connection duct 41 is connected to the opening provided at the lower end of the housing 31A of the air conditioning unit 31. The upstream end of the connection duct is connected to the air conditioning unit 31 further toward the vehicle front side than the dash panel 10.

A downstream end of the connection duct 41 is connected to an upstream end of the branched duct 42. The connection duct 41 connects the air conditioning unit 31 and the branched duct 42. The connection duct 41 guides air that has been discharged from the air conditioning unit 31 to the branched duct 42.

The connection duct 41 is inserted through a through hole 10A provided at the dash panel 10 at an intermediate position thereof. A portion of the connection duct 41 is covered from the upper side by the floor carpet 17. That is to say, it is provided at the lower side of the floor carpet 17.

The connection duct 41 integrally includes a first portion 41A that is connected to the air conditioning unit 31 and extends in the up-down direction, a second portion 41B that bends from a downstream end of the first portion 41A and extends toward the vehicle rear side, and a third portion 41C that bends from a downstream end of the second portion 41B and extends toward the vehicle upper side and the vehicle rear side.

The first portion 41A is provided at the front compartment S2. An upstream end of the first portion 41A is connected to the air conditioning unit 31. The downstream end of the first portion 41A is connected to the second portion.

The second portion 41B extends linearly along the vehicle front-rear direction. An upstream end of the second portion 41B is connected to the first portion 41A. A downstream end of the second portion 41B is connected to the third portion 41C.

The second portion 41B is inserted through the through hole 10A provided at the dash panel 10. That is to say, an upstream portion of the second portion 41A is provided at the front compartment S2, and a downstream portion of the second portion 41A is provided at the vehicle cabin S1. The downstream portion of the second portion 41A (the portion provided at the vehicle cabin S1) is provided at a central portion in the vehicle width direction, and is provided at an upper side of the floor panel 16. Further, the downstream portion of the second portion 41A (the portion provided at the upper side of the floor panel 16) is covered by the floor carpet 17 from the upper side.

The third portion 41C is provided at the internal space S3 of the console 20. The third portion 41C extends so as to be inclined with respect to a horizontal direction. The third portion 41C extends toward the vehicle upper side and the vehicle rear side. An upstream end of the third portion 41C is connected to the second portion 41B. A downstream end of the third portion 41C is connected to the upstream end of the branched duct 42.

The branched duct 42 is provided at the internal space S3 of the console 20. The branched duct 42 is provided further toward the vehicle front side than the console box 21. The branched duct 42 is provided at a lower side of the cup holder 23. The branched duct 42 is provided at the vehicle rear side of the instrument panel 11. The branched duct 42 is provided between the pair of seats 12. A position of the branched duct 42 in the vehicle front-rear direction is substantially the same as that of the seats 12.

An upstream end of the branched duct 42 is connected to the connection duct 41 (specifically to the third portion 41C of the connection duct 41). The branched duct 42 causes air that has been guided from the connection duct 41 to branch and supplies it to the first duct 43 and the second duct 44.

As illustrated in FIG. 2, the branched duct 42 integrally includes an upstream portion 42A that is connected to the connection duct 41, and a first branched portion 42B and a second branched portion 42C that are connected to a downstream side (a vehicle rear side in the present exemplary embodiment) of the upstream portion 42A. The first branched portion 42B is provided further toward the upper side than the second branched portion 42C. A first discharge port 42B1 is provided at a downstream end of the first branched portion 42B. Further, a second discharge port 42C1 is provided at a downstream end of the second branched portion 42C. The first branched portion 42B and the second branched portion 42C extend along the vehicle front-rear direction. The first branched portion 42B and the second branched portion 42C are provided in parallel.

A flow path through which air flows is provided at an interior of the upstream portion 42A. Further, flow paths through which air flows are also provided at interiors of the first branched portion 42B and the second branched portion 42C. The flow path that is provided at the interior of the first branched portion 42B and the flow path that is provided at the interior of the second branched portion 42C are in a parallel relationship. The flow paths that are provided at the interiors of the first branched portion 42B and the second branched portion 42C are each connected to the flow path that is provided at the interior of the upstream portion 42A. Air that has been introduced to the flow path that is provided at the interior of the upstream portion 42A is branched to the flow paths that are provided at the interiors of the first branched portion 42B and the second branched portion 42C.

As illustrated in FIG. 1, the branched duct 42 includes a first lid portion 46 and a second lid portion 47. The first lid portion 46 is provided at the first branched portion 42B. The first lid portion 46 is configured to be capable of opening and closing the first discharge port 42B1 that is provided at the first branched portion 42B. That is to say, the first lid portion 46 is configured to be capable of switching between a state in which the first discharge port 42B1 is closed and a state in which the first discharge port 42B1 is open. The second lid portion 47 is provided at the second branched portion 42C. The second lid portion 47 is configured to be capable of opening and closing the second discharge port 42C1 that is provided at the second branched portion 42C. That is to say, the second lid portion 47 is configured to be capable of switching between a state in which the second discharge port 42C1 is closed and a state in which the second discharge port 42C1 is open.

As illustrated in FIG. 1, the first duct 43 extends along the vehicle front-rear direction. The first duct 43 is provided at the internal space S3 of the console 20.

An upstream end of the first duct 43 is connected to the first branched portion 42B of the branched duct 42. Specifically, the upstream end of the first duct 43 is connected to the first discharge port 42B1 of the first branched portion 42B. A downstream end of the first duct 43 is connected to the first blowing port 20B that is provided at the console 20. The first duct 43 connects the first blowing port 20B of the console 20 and the first discharge port 42B1 of the branched duct 42. The first duct 43 is provided at a lower side of the console box 21.

The second duct 44 extends along the vehicle front-rear direction. The second duct 44 is provided at the internal space S3 of the console 20.

An upstream end of the second duct 44 is connected to the second branched portion 42C of the branched duct 42. Specifically, the upstream end of the second duct 44 is connected to the second discharge port 42C1 of the second branched portion 42C. A downstream end of the second duct 44 is connected to the second blowing port 20C that is provided at the console 20. The second duct 44 connects the second blowing port 20C of the console 20 and the second discharge port 42C1 of the branched duct 42. The second duct 44 is provided at the lower side of the console box 21. A diameter of a downstream end portion of the second duct 44 is increased.

It should be noted that, for example, an area obtained by totaling a flow path area of the first duct 43 and a flow path area of the second duct 44 may be larger than a flow path area of the connection duct 41. In other words, per unit length, a volume obtained by totaling a volume of the first duct 43 and a volume of the second duct 44 may be larger than a volume of the connection duct 41. In such a case, due to providing the branched duct 42 at the downstream side of the air conditioning duct 40, a length of the connection duct 41, which has a relatively small volume, becomes longer, and lengths of the first duct 43 and the second duct 44, which have a relatively large total volume, become shorter. Accordingly, a volume of the entire air conditioning duct 40 can be reduced, and therefore, cramping of the vehicle cabin S1 can be suppressed.

### Flow of Air

Next, flow of air in the vehicle air conditioning device 30 of the present exemplary embodiment will be explained.

As illustrated in FIG. 1, air whose temperature has been adjusted at the air conditioning unit 31 is discharged to the air conditioning duct 40 that is connected to the housing 31A of the air conditioning unit 31. The air that has been discharged to the air conditioning duct 40 flows through the inside of the air conditioning duct 40 and is discharged to the vehicle cabin S1.

Specifically, the air that has been discharged from the air conditioning unit 31 first flows through the inside of the connection duct 41. The air that has flowed through the inside of the connection duct 41 is introduced into the branched duct 42. The air that has been introduced into the branched duct 42 is divided in two portions.

One portion of the air that has been divided into two portions is introduced into the first duct 43 via the first branched portion 42B. The air that has been introduced into the first duct 43 flows through the inside of the first duct 43, and is discharged to the vehicle cabin S1 (specifically, to the space at the rear side of the driver's seat and the passenger seat within the vehicle cabin S1) from the first blowing port 20B that is provided at the upper portion of the console 20. It should be noted that the first blowing port 20B may be, for example, a rear face blowing port that blows air toward a vicinity of a head of an occupant seated at a rear seat (which is not illustrated in the drawings).

Further, the other portion of the air that has been divided into two portions at the branched duct 42 is introduced into the second duct 44 via the second branched portion 42C. The air that has been introduced into the second duct 44 flows through the inside of the second duct 44, and is discharged to the vehicle cabin S1 (specifically, to the space at the rear side of the driver's seat and the passenger seat within the vehicle cabin S1) from the second blowing port 20C that is provided at the lower portion of the console 20. It should be noted that the second blowing port 20C may be, for example, a rear foot blowing port that blows air toward a vicinity of a foot of the occupant seated at the rear seat (which is not illustrated in the drawings).

### Operation and Effects

According to the present exemplary embodiment, the following operation and effects are achieved.

In the present exemplary embodiment, the branched duct 42 is provided at the interior of the console 20. Consequently, the vehicle cabin S1 interior space can be made larger compared to a case in which the branched duct 42 is provided at an exterior of the console 20 (that is to say, in the vehicle cabin S1).

Further, in the present exemplary embodiment, the upstream end of the connection duct 41 is connected to the air conditioning unit 31 further toward the vehicle front side than the dash panel 10. Consequently, the portion of the air conditioning unit 31 that is connected to the air conditioning duct 40 (the connection duct 41) does not need to be provided further toward the vehicle cabin S1 side than the dash panel 10. Accordingly, the vehicle cabin S1 can be made larger.

In the present exemplary embodiment, the connection duct 41 is disposed at the lower side of the floor carpet 17. Consequently, the connection duct 41 is less likely to cramp the vehicle cabin S1 interior space. Accordingly, the vehicle cabin S1 can be made larger.

In the present exemplary embodiment, the air conditioning duct 40 includes the first duct 43 that connects the first blowing port 20B of the console 20 and the first discharge port 42B1 of the branched duct 42, and the second duct 44 that connects the second blowing port 20C of the console 20 and the second discharge port 42C1 of the branched duct 42. That is to say, in the present exemplary embodiment, the vehicle cabin S1 can be made larger in a structure in which air, whose temperature has been adjusted at the air conditioning unit 31, is discharged to the vehicle cabin S1 interior space from plural locations (specifically, the first blowing port 20B and the second blowing port 20C).

In the present exemplary embodiment, the branched duct 42 includes the first lid portion 46 that is capable of opening and closing the first discharge port 42B1, and the second lid portion 47 that is capable of opening and closing the second discharge port 42C1. Consequently, the branched duct 42 can switch between states in which the first discharge port 42B1 and the second discharge port 42C1 are open and states in which the first discharge port 42B1 and the second discharge port 42C1 are closed. Accordingly, switching between a state in which air, whose temperature has been adjusted, is discharged from the first blowing port 20B and a state in which the air is not discharged can be carried out. Further, switching between a state in which air, whose temperature has been adjusted, is discharged from the second blowing port 20C and a state in which the air is not discharged can be carried out. Thus, the temperature of the vehicle cabin S1 can be suitably adjusted.

Further, in a case in which a structure is employed in which air is guided to only one blowing port by the air conditioning duct 40, this can be accommodated by closing the first lid portion 46 or the second lid portion 47. By providing the first lid portion 46 or the second lid portion 47 in this manner, both a case in which there is only one blowing port and a case in which there are plural blowing ports can be accommodated. Accordingly, versatility can be improved.

Although the vehicle air conditioning device according to the exemplary embodiment has been explained above, design modifications can be appropriately applied to the present disclosure within a range that does not depart from the spirit thereof.

For example, although an example in which an entirety of the air conditioning unit 31 is provided at the front compartment S2, which is at the vehicle front side of the dash panel 10, has been explained in the above-described exemplary embodiment, the present disclosure is not limited thereto. For example, a portion of the air conditioning unit 31 (e.g., a rear portion in the vehicle front-rear direction) may be provided further toward the vehicle rear side than the dash panel 10. Specifically, for example, a portion of the air conditioning unit 31 may be provided at the vehicle front side of the instrument panel 11 (that is to say, at the interior of the instrument panel 11).

Further, for example, although an example in which a connection portion between the air conditioning unit 31 and the air conditioning duct 40 is provided further toward the vehicle front side than the dash panel 10 has been explained in the above-described exemplary embodiment, the present disclosure is not limited thereto. For example, the connection portion between the air conditioning unit 31 and the air conditioning duct 40 may be provided further toward the vehicle rear side than the dash panel 10. Specifically, for example, the connection portion between the air conditioning unit 31 and the air conditioning duct 40 may be provided at the vehicle rear side of the dash panel 10 and at the vehicle front side of the instrument panel 11.

Furthermore, although an example in which the connection duct 41 of the air conditioning duct 40 is disposed at the lower side of the floor carpet has been explained in the above-described exemplary embodiment, the present disclosure is not limited thereto. For example, the connection duct 41 may be disposed at the upper side of the floor carpet 17.

Further, although an example in which the downstream end of the air conditioning duct 40 is connected to the first blowing port 20B and the second blowing port 20C that are provided at the console 20 has been explained in the above-described exemplary embodiment, the present disclosure is not limited thereto. For example, the downstream end of the air conditioning duct 40 may be connected to another discharge port (blowing port) that supplies air to the vehicle cabin S1.

Furthermore, although an example in which the area obtained by totaling the flow path area of the first duct 43 and the flow path area of the second duct 44 is larger than the flow path area of the connection duct 41 has been explained in the above-described exemplary embodiment, the present disclosure is not limited thereto. The area obtained by totaling the flow path area of the first duct 43 and the flow path area of the second duct 44 may be equal to the flow path area of the connection duct 41. Further, the area obtained by totaling the flow path area of the first duct 43 and the flow path area of the second duct 44 may be smaller than the flow path area of the connection duct 41.

What is claimed is:

1. A vehicle air conditioning device comprising:
an air conditioning unit that is provided further toward a vehicle front side than a dash panel separating a vehicle cabin and a front compartment, and that adjusts a temperature of air that is guided to the vehicle cabin; and
an air conditioning duct that guides air, whose temperature has been adjusted at the air conditioning unit, to the vehicle cabin,
wherein:
the air conditioning duct includes:
a connection duct that has an upstream end connected to the air conditioning unit, and
a branched duct that has an upstream end connected to the connection duct, and at which air that has been guided from the connection duct is branched;
the branched duct is provided at an interior of a console that is provided further toward a vehicle rear side than the dash panel; and
the upstream end of the connection duct is connected to the air conditioning unit further toward the vehicle front side than the dash panel.

2. The vehicle air conditioning device according to claim 1, wherein the connection duct is disposed at a lower side of a floor carpet.

3. The vehicle air conditioning device according to claim 1, wherein:
the branched duct is provided with a first discharge port and a second discharge port from which air is discharged;
the console is provided with a first opening portion that is open toward the vehicle cabin at an upper portion of a rear end portion of the console, and a second opening portion that is open toward the vehicle cabin at a lower portion of the rear end portion of the console; and
the air conditioning duct includes a first duct that connects the first opening portion of the console and the first discharge port of the branched duct, and a second duct that connects the second opening portion of the console and the second discharge port of the branched duct.

4. The vehicle air conditioning device according to claim 2, wherein:
the branched duct is provided with a first discharge port and a second discharge port from which air is discharged;
the console is provided with a first opening portion that is open toward the vehicle cabin at an upper portion of a rear end portion of the console, and a second opening portion that is open toward the vehicle cabin at a lower portion of the rear end portion of the console; and
the air conditioning duct includes a first duct that connects the first opening portion of the console and the first discharge port of the branched duct, and a second duct that connects the second opening portion of the console and the second discharge port of the branched duct.

5. The vehicle air conditioning device according to claim 3, wherein the branched duct includes a first lid portion that is capable of opening and closing the first discharge port, and a second lid portion that is capable of opening and closing the second discharge port.

6. The vehicle air conditioning device according to claim 4, wherein the branched duct includes a first lid portion that is capable of opening and closing the first discharge port, and a second lid portion that is capable of opening and closing the second discharge port.
